(19) United States
(12) Patent Application Publication
(10) Pub. No.: US 2006/0047812 A1
(43) Pub. Date: Mar. 2, 2006

(54) Network audio file receiver system for connecting home stereo to wide band network

(75) Inventors: Cheng-Shing Lai, Taipei Hsien (TW); Zheng-Rong Zou, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,199

(22) Filed: Jun. 23, 2004

(51) Int. Cl. G06F 15/173

(52) U.S. Cl. 709/226

(57) ABSTRACT

The present invention is to provide a network audio file receiver system for connecting a home stereo to a wide band network, which comprises a network audio file receiver coupled to a home stereo for receiving and playing audio files sent from an Internet radio via an Internet protocol sharing device and a wide band modem when the wide band modem is coupled to the Internet. When the network audio file receiver is not coupled to the Internet, the home stereo is still adapted to play audio files downloaded from the Internet and stored in the hard disk of the PC.

### FIELD OF THE INVENTION

The present invention relates to a network audio file receiver system for connecting a home stereo to a wide band network, more particularly to a system enabling a home stereo to play audio files sent from an Internet radio or run a play program to play audio files downloaded from the Internet and stored in the hard disk of a PC.

### BACKGROUND OF THE INVENTION

The booming of LAN (Local Area Network) and the Internet not only increases information communication but also increases information communication rate and quality. Further, the information communication cost is reduced, information communication is facilitated, and information is even widely spread due to the availability of inexpensive computers. Currently, a person may download any free audio files (e.g., audio files in the form of MP3, WMA, and WAV) from the Internet to a computer coupled thereto, and then run a play program installed in the computer to play the audio files or retrieve audio files from an Internet radio over the Internet. Unfortunately, the conventional home stereo can only play a typical media or receive the sound waves from a radio station rather than play audio files from an Internet radio over the Internet or play audio files from the hard disk of a computer in which the audio files have been downloaded from the Internet and stored therein. Hence, a need for improvement exists.

### SUMMARY OF THE INVENTION

A primary object of the present invention is to provide a network audio file receiver system for connecting a home stereo to a wide band network. The network audio file receiver system comprises a home stereo, a network audio file receiver, an Internet protocol sharing device, a PC and a wide band modem wherein the Internet protocol sharing device is coupled to the network audio file receiver, the wide band modem and the PC respectively; the network audio file receiver is coupled to the home stereo and comprises at least one of TCP/IPs and a play program; the network audio file receiver uses the corresponding TCP/IP to receive audio files sent from an Internet radio via the Internet protocol sharing device and the wide band modem when the wide band modem is coupled to the Internet, enabling the home stereo to play the audio files thereafter; and when the network audio file receiver is not coupled to the Internet, the home stereo or the play program is adapted to play audio files downloaded from the Internet and stored in the hard disk of the PC.

By utilizing the present invention, it is possible of enabling a home stereo to play audio files sent from an Internet radio or run a play program to play audio files stored in the hard disk of a PC, and overcoming the above drawbacks of the prior art, such as the conventional home stereo can only play a typical media or receive the sound waves from a radio station rather than play audio files from an Internet radio by connecting to the Internet and cannot play audio files from the hard disk of a computer in which the audio files have been downloaded from the Internet and stored in the hard disk.

The above and other objects, features and advantages of the present invention will become apparent from the following detailed description taken with the accompanying drawings.

### BRIEF DESCRIPTION OF THE DRAWINGS

FIG. 1 is a block diagram of the invention; and

FIG. 2 is a block diagram of a preferred embodiment of network audio file receiver system according to the invention.

### DETAILED DESCRIPTION OF THE PREFERRED EMBODIMENTS

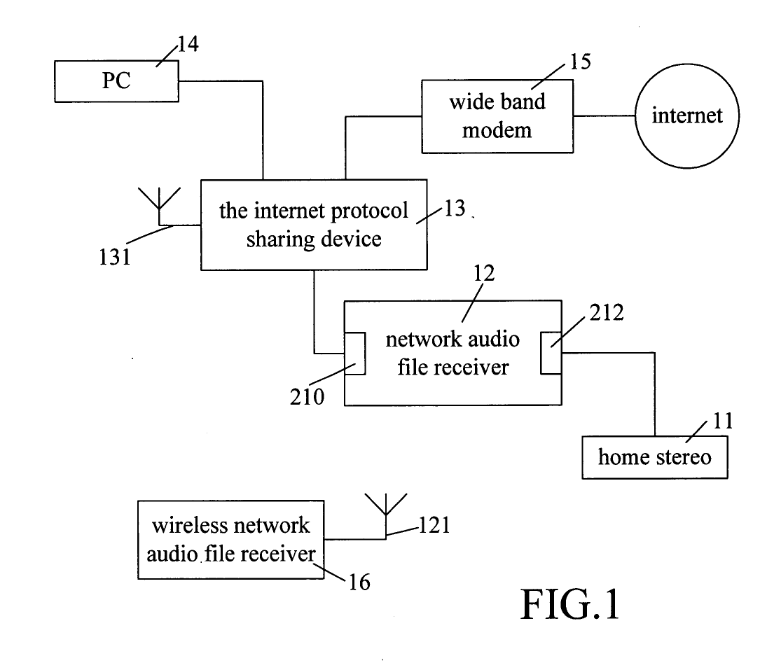

Referring to FIG. 1, there is shown a network audio file receiver system for connecting a home stereo to a wide band network (e.g., the Internet) in accordance with the invention comprising a home stereo 11, a network audio file receiver 12, an Internet protocol sharing device 13, a PC (personal computer) 14, and a wide band modem 15. The Internet protocol sharing device 13 is coupled to the network audio file receiver 12, the wide band modem 15, and the PC 14 respectively. When the wide band modem 15 is coupled to the Internet, packets from the Internet can be sent to the Internet protocol sharing device 13 via the wide band modem 15. The Internet protocol sharing device 13 then sends the packets to the PC 14 or the network audio file receiver 12 by using a corresponding TCP/IP (Transmission Control Protocol/Internet Protocol). The network audio file receiver 12 comprises at least one of TCP/IPs and a play program, and is coupled to the home stereo 11.

Referring to FIG. 1 again, when the wide band modem 15 is coupled to the Internet, the network audio file receiver 12 may use a corresponding TCP/IP to receive audio files sent from an Internet radio via the Internet protocol sharing device 13 and the wide band modem 15. The audio files are then played out by the home stereo 11.

When the wide band modem 15 is not coupled to the Internet, the network audio file receiver 12 is also adapted to couple to the PC 14 via the Internet protocol sharing device 13, enabling the home stereo 11 to play audio files (e.g., audio files in the form of MP3, WMA, and WAV) downloaded from the Internet and stored in the hard disk of the PC 14.

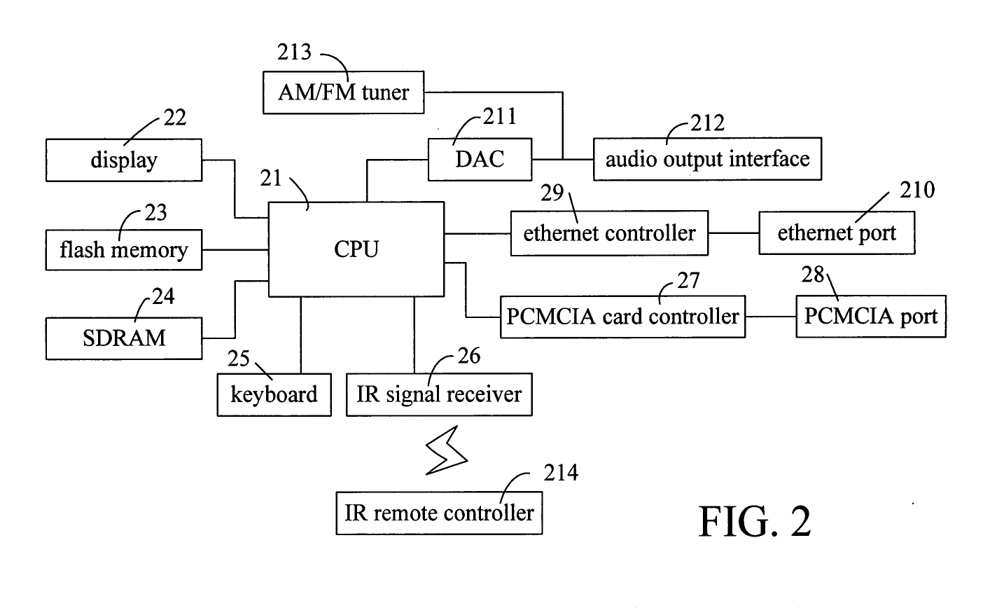

Referring to FIG. 2 in conjunction with FIG. 1, the network audio file receiver 12 comprises a CPU (central processing unit) 21, a display (e.g., LCD (liquid crystal display)) 22, a flash memory 23, a SDRAM (static dynamic random access memory) 24, a keyboard 25, an IR (infrared) signal receiver 26, a PCMCIA (Personal Computer Memory Card International Association) card controller 27, a PCMCIA port 28, an Ethernet controller 29, an Ethernet port 210, an DAC (digital-to-analog converter) 211, an audio output interface 212, an AM (amplitude modulation)/FM (frequency modulation) tuner 213, and an IR remote controller 214. The CPU 21 has been installed with a play program for playing audio files in the form of MP3, WMA, and WAV and is able to send data being processed (or processed data) to the display 22 for showing. The CPU 21 can also store the data being processed in the SDRAM 24 and then process the data therein in a TDMA (time division multiple access) manner. The CPU 21 further can either write the processed data into the flash memory 23 or read the data from the flash memory 23. A user may use the keyboard 25 to input a command to the CPU 21 for executing an operation corresponding to the received command. Alternatively, a user may use the IR remote controller 214 to input a command to the IR signal receiver 26, the IR signal receiver 26 then sends the same to the CPU 21 for executing an operation corresponding to the received command. The PCMCIA port 28 is coupled to a PCMCIA card (not shown), enabling the PCMCIA card controller 27 to control the signal communication between the PCMCIA card and the CPU 21. The Ethernet port 210 is coupled to the Internet protocol sharing device 13 (see FIG. 1), enabling the Ethernet controller 29 to control the signal communication between the Internet and the CPU 21 via the Internet protocol sharing device 13. The audio output interface 212 is coupled to the home stereo 11 (see FIG. 1), which enables the CPU 21 to send the audio files received from the Internet radio or the audio files downloaded from the Internet and stored in the hard disk of the PC 14 to the DAC 211. In the DAC 211, the audio files are converted into analog ones which are in turn sent to the home stereo 11 via the AM/FM tuner 213. Eventually, the audio files are played out by the home stereo 11 via its left and right channels.

Referring to FIG. 2 again, a user may input commands by means of the keyboard 25 to set TCP/IP of the network audio file receiver 12 for listening to a desired Internet radio. Alternatively, the user may use the IR remote controller 214 to set TCP/IP associated with a desired Internet radio or play the audio files downloaded from the Internet and stored in the hard disk of the PC 14.

Referring to FIG. 2 again, the CPU 21 of the network audio file receiver 12 comprises a DHCP (dynamic host configuration protocol) so as to dynamically set TCP/IP of each Internet radio.

Referring to FIG. 1 again, when a wireless network transceiver 121 having a PCMCIA port is connected to the PCMCIA port 28 of the network audio file receiver 12, the network audio file receiver 12 is served as a wireless network audio file receiver 16. Thus, when a wireless network transceiver 131 is installed in the Internet protocol sharing device 13, the Internet protocol sharing device 13 is able to communicate signals with the wireless network audio file receiver 16 via the wireless network transceiver 131.

Summing up the above, the home stereo 11 of the invention is able to play audio files sent from an Internet radio or play audio files downloaded from the Internet and stored in the hard disk of the PC 14.

While the invention has been described by means of specific embodiments, numerous modifications and variations could be made thereto by those skilled in the art without departing from the scope and spirit of the invention set forth in the claims.

What is claimed is:

1. A network audio file receiver system for connecting a home stereo to a wide band network, comprising a home stereo, a network audio file receiver, an Internet protocol sharing device, a PC, and a wide band modem wherein:
the Internet protocol sharing device is coupled to the network audio file receiver, the wide band modem, and the PC respectively;
the network audio file receiver comprises at least one of TCP/IPs and a play program, and is coupled to the home stereo;
when the wide band modem is coupled to the Internet, packets of audio files received from the Internet can be sent to the Internet protocol sharing device via the wide band modem, the Internet protocol sharing device then sends the audio files to the PC or the network audio file receiver by using a corresponding TCP/IP, the network audio file receiver then sends the audio files to the home stereo, enabling the play program installed in the home stereo to play the audio files thereafter; when the wide band modem is not coupled to the Internet, the network audio file receiver is still adapted to couple to the PC via the Internet protocol sharing device, enabling the play program installed in the home stereo to play the audio files downloaded from the Internet and stored in a hard disk of the PC.

2. The network audio file receiver system of claim 1, wherein the network audio file receiver comprises:
a CPU being installed with the play program for playing audio files;
a display being connected to the CPU for showing data sent therefrom;
a SDRAM being connected to the CPU for storing data being processed in a TDMA manner;
a flash memory being connected to the CPU for writing the processed data thereto or reading data therefrom;
a keyboard being connected to the CPU for inputting a command
an IR signal receiver being connected to the CPU for receiving a command from an IR remote controller;
a PCMCIA card controller being connected between the CPU and a PCMCIA port for controlling a signal communication therebetween;
an Ethernet controller being connected between the CPU and an Ethernet port coupled to the Internet protocol sharing device for controlling a signal communication between the Internet protocol sharing device and the CPU over the Internet;
a DAC being connected between the CPU and an audio output interface coupled to the home stereo for sending audio files sent from the CPU to the home stereo.

3. The network audio file receiver system of claim 2, wherein the network audio file receiver further comprises an AM/FM tuner being connected to the DAC for sending analog audio signals to the home stereo.

4. The network audio file receiver system of claim 2, wherein a setting of the TCP/IP associated with the network audio file receiver is done by inputting a command from the keyboard so as to enable a person to listen to a desired Internet radio.

5. The network audio file receiver system of claim 2, wherein using the TCP/IP associated with the IR remote controller will enable to use the TCP/IP associated with a desired Internet radio or play the audio files from the hard disk of the PC, the audio files being downloaded from the Internet.

6. The network audio file receiver system of claim 2, wherein the display is an LCD.

7. The network audio file receiver system of claim 1, wherein the audio file is in the form of MP3.

8. The network audio file receiver system of claim 1, wherein the audio file is in the form of WMA.

9. The network audio file receiver system of claim 1, wherein the audio file is in the form of WAV.
